(19) United States
(12) Patent Application Publication
(10) Pub. No.: US 2006/0146070 A1
(43) Pub. Date: Jul. 6, 2006

(54) Method for generating and inputting mnemonic devices and article for registering the input arrangement

(76) Inventor: Chiew Ying Chow, Boon Lay Drive (SG)

Correspondence Address: WELSH & KATZ, LTD, 120 S RIVERSIDE PLAZA, 22ND FLOOR, CHICAGO, IL, 60606, US

(21) Appl. No.: 10/538,986

(22) PCT Filed: Dec. 16, 2003
(86) PCT No.: PCT/SG03/00285

§ 371 Date: Dec. 19, 2005

(30) Foreign Application Priority Data
Jan. 30, 2003 (SG) 200300221-9

(51) Int. Cl. G09G 5/00

(52) U.S. Cl. 345/619

(57) ABSTRACT

Method for generating and inputting mnemonic devices and article for registering the input arrangement A method for inputting a mnemonic device on a numeric keypad wherein the spatial arrangement of the input is recorded. The invention provides for a method for generating a mnemonic device from a list of keywords to be memorised and inputting said generated mnemonic device on a numeric keypad wherein the spatial arrangement of the input is recorded. The spatial arrangement of the input is registered on an input record means which may be embodied as a sheet provided with the keypad layout upon which the spatial arrangement in which the sequence of keys being pressed in respect of the mnemonic device being inputted may be performed with the user's finger. The input record is provided in the form of a computer-implemented storage, which is retrievable.

### TECHNICAL FIELD

This invention relates to a method for generating mnemonic devices and for inputting them in a manner to facilitate ease of memorising the generated mnemonic devices. An article facilitating the recording of an input arrangement for ease of memorising according to the method is also disclosed.

### BACKGROUND ART

The principle of “mnemonics” (also scientifically called “memoria technical”) is to create in the mind an artificial structure that incorporates unfamiliar ideas, particularly dissociated ideas, that are by themselves difficult to remember. Ideally, the structure is designed so that its parts are mutually suggestive.

A “mnemonic device” is therefore any aid facilitating memory. In this specification, the word “device”, when used in the context of mnemonics, carries the meaning of the product or result of the act of devising, e.g. ploy, stratagem, ruse, symbol, means, way or manner of doing something (and not in the sense of a machine or tool).

Numerous mnemonic techniques have been devised since the Greco-Roman civilization. Examples of such techniques include the loci method, acronyms and rhyming.

The loci method involves visualising images of the things to be memorised and mentally placing them in an orderly arrangement of locations. The method combines a familiar structure (locus) and the item or thing to be remembered (res). This mnemonic method, which is also referred to as loci et res, is an effective way to remember a series of items in serial order.

An acronym is the combination of the first syllables or letters of component words within phrases or within names having more than one word. Acronyms are often pronounced as words such as the term “laser” being an acronym derived from light amplification by stimulated emission of radiation. Often such acronyms are pronounced as words and later cease to be considered abbreviations or even acronym as in the case of “laser”. The use of acronyms may assist in memorising a list of words if the first syllables or letters of the words forms an easily-memorised word such as “HOMES” for the 5 great lakes of North America which names are arranged in order accordingly: Huron, Ontario, Michigan, Erie and Superior.

Rhyming. Grouping items in rhymed verse has long been a popular mnemonic technique, which is also known as acrostics. The term is derived from the Greek words akros, “at the end,” and stichos, “line,” or “verse.” An acrostic is a word or sentence so constructed that the initial letters of the lines, taken consecutively, form words or sentence that rhymes, i.e. the first letter of each word is the same as the initials of the word to be memorised. The acrostic word or sentence need not make sense. Examples:
First 4 U.S. Presidents: “Watch a jockey moves”
   for Washington, Adams, Jefferson, and Madison.
Names of cranial nerves: “On old Olympus, towering top, a friar and Greek viewed some hops”
   for olfactory, optic, oculomotor, trochlear, trigeminal, abducens, facial, auditory, glossopharyngeal, vagus, spinal accessory, and hypoglossal.

Modern scientific interest in mnemonics grew rapidly after a Soviet psychologist, Aleksandr R. Luria wrote in The Mind of a Mnemonist (1968) that suggested the field as worthy of serious scientific psychological study.

A number of patent publications exist on generating mnemonic devices. This includes US 2003/0068604-A1 (Krasney) entitled “Personal mnemonic generator” which is cited herein as a complementary art. This patent publication discloses a method and apparatus for generating acrostic mnemonic devices which method is embodied in a computer program. The mnemonic devices generated are based on the user's customised areas of interest so that the acrostic mnemonic devices are easy to be remembered by the user. There is, however, no disclosure in the specification on the use of any tools or devices for extending the ease of memorising such acrostic mnemonic devices by visual-spatial means.

With the advent of cellular phones and the mass-marketing of handsets for such cellular telecommunications, which are affordable to even students and teenagers to own, there is a growing proficiency in using the handsets' keypad for the input of alphabets to form short messages and have the messages transmitted via the cellular service provider's short message service (SMS).

Such proficiency is usually based on visual-spatial aptitude often found in younger people, which perhaps explain their natural proficiency in playing computer or console games. Their apparent ease of learning visual-spatial skills as a matter of course or routine is also an advantage.

In the case of the keypad layout of the cellular phones, modifications to the standard layout are often proposed, for example by US 2003/0048894-A1 (Mager), which is cited herein also as a complementary art. This publication, too, does not disclose any means for visual-spatial methods for extending the ease of memorising mnemonic devices.

Amongst such young people and students are often found weak learners who have difficulty remembering words or lists of terms in their studies. Research conducted on such slow or weak learners found that their weakness was due to their inability to form mnemonic devices, including acronyms and acrostics in their learning of difficult information—[see Carbo, M., Dunn, R., & Dunn, K., Teaching Students Read through Their Individual Learning Styles, Prentice-Hall, New York (1986)].

It is therefore proposed herein that memory tools be developed for weak learners to overcome their difficulties in remembering words or lists of terms. Weak learners' natural ability and preference to use visual-spatial skills may be harnessed to overcome their learning weakness by providing them with memory tools to remember information better through the use of acronyms and visual-spatial means.

### STATEMENT OF INVENTION

To achieve the aforementioned objects and overcome the drawbacks of the conventional mnemonic methods, the present invention provides, as the general embodiment, a method for inputting a mnemonic device on a numeric keypad wherein the spatial arrangement of the input is recorded.

In one aspect of the invention, the numeric keypad includes any one of a telephone keypad layout, a calculator keypad layout and a computer keyboard's numeric keys array which is provided with a mode for entering alphanumeric characters in addition to the numeric mode for generating dual tone multi-frequency (DTMF) signal. The numeric keypad of the calculator and computer keyboard's numeric keys array preferably includes a user-executable program enabling the layout to be changed to that of a telephone keypad layout.

In one aspect of the keypad, the numeric keypad is provided with a mode for entering radicals of an East Asian language script, including any one of Chinese, Japanese and Korean, in addition to the numeric mode for generating DTMF signal.

In a second aspect, the invention provides for a method for generating a mnemonic device from a list of keywords to be memorised and inputting said generated mnemonic device on a numeric keypad wherein the spatial arrangement of the input is recorded.

In a specific embodiment, the mnemonic device is generated by the steps of:
(i) arranging the keywords to be memorised in a list;
(ii) short-listing said keyword list by the first alphabet of each keyword;
(iii) rearrange said first alphabets to combine in different permutations;
(iv) user chooses at least one combination of the alphabets that forms a word meaningful to said user;
(v) user input said word onto a numeric keypad and record the spatial arrangement of the input.

Preferably, the word formed of the alphabets' combination includes acronyms or words whereby a word most meaningful to the user is chosen. The list of words formed of the permutation of alphabets is crosschecked against a database of dictionary words whereby words having meaning are short-listed for the user to choose.

In one embodiment, the list of words formed of the permutation of alphabets is grouped into at least two groups to form at least two words. In another embodiment, the mnemonic device generated in the form an acrostic which may be formed from cross-checking words formed from the permutations of the alphabets' combination against a database of acrostic words, phrases, sentences and the like.

In a preferred embodiment, the generated acrostics, including words, which are new to the database, are incorporated thereinto, hence expanding said database for future cross-checking, particularly when the database and the cross-checking engine is implemented in a computer.

In another important aspect of the invention, the spatial arrangement of the input is registered on an input record means which may be embodied as a sheet provided with the keypad layout upon which the spatial arrangement in which the sequence of keys being pressed in respect of the mnemonic device being inputted may be performed with the user's finger.

In one embodiment, the input record means is a mat provided with the keypad layout upon which the spatial arrangement comprising the sequence of keys being pressed in respect of the mnemonic device being inputted may be performed with footsteps of the user. In another embodiment, the input record means is a sheet comprised of a sticker dispensable from a stack in convenient size for manually registering the input's spatial arrangement and for sticking onto a page containing educational or instructional materials.

In another embodiment, the input record is provided in the form of a computer-implemented storage, which is retrievable for output to a visual display, animation replay of the input's spatial arrangement, test a user for the correct input, and incorporate said record into a database, hence expanding said database for enhanced future implementation.

### LIST OF ACCOMPANYING DRAWINGS

The method of the present invention will be better understood with the following detailed description with reference to the accompanying drawings, which describe specific embodiments as examples or illustrations, in which

FIG. 1 is a user-interface display of The Acronym Creator (TAC) program for input purposes according to one aspect of the invention;

FIG. 2 is a user-interface display of The Acronym Creator (TAC) program for output purposes according to one aspect of the invention;

FIGS. 3-7 show the logic flowchart of The Acronym Creator (TAC) program;

FIG. 8 shows a representation of the input record means in the form of a V-S Pad™;

FIG. 9 shows a worked out sample of the input record on a V-S Pad™ layout in one embodiment;

FIG. 10 shows another embodiment of the input record on a V-S Pad™ worked out in another method.

### DETAILED DESCRIPTION OF EMBODIMENTS

In a general and broad sense, the invention comprises of a method for inputting a mnemonic device on a numeric keypad wherein the spatial arrangement of the input may be recorded. The mnemonic device may one that is a well-known acronym or acrostic, or one that is derived manually by, or instructed upon, a user who may have difficulty memorising such information.

“Numeric keypad” is to be understood in this specification to include both physical keypads such as that of a telephone as well as virtual keypads such as that generated by a computer program on a display, including touch-screens, generated by projecting onto a surface and image of a keypad printed on printable materials.

By inputting said mnemonic device into a keypad of a hand phone, for example, that is enabled to input alphabetical or alphanumeric characters, the user will have to physically key-in said mnemonic letters on the keypad the manner in which the fingers move about the keypad to input the mnemonic letters comprises the spatial arrangement of the input, which may be easily noted or recorded by the user.

It will be recognised that the manner in which the spatial arrangement, including the visual-spatial arrangement, of inputting the mnemonic device will depend on the keypad layout or format of the particular apparatus used, i.e. whether it is a telephone, calculator or computer keyboard's numeric keys array. The former layout's numerals progress in threes from 1 to 9 from the top downwards while the latter two layouts have the numerals progress, also in threes, from 1 to 9 from the bottom upwards as shown in the following Tables I and II respectively.

TABLE I
Telephone numeric keypad layout

| | | |
|---|---|---|
| 1 | 2 | 3 |
| 4 | 5 | 6 |
| 7 | 8 | 9 |
| | 0 | |

TABLE II
Numeric keypad layout of calculator/computer keyboard

| | | |
|---|---|---|
| 7 | 8 | 9 |
| 4 | 5 | 6 |
| 1 | 2 | 3 |
| | 0 | |

While the rest of the examples in this specification is based on the telephone's standard numeric keypad layout, a person skilled in the art will recognise that the numeric keypads of the calculator and computer keyboard's numeric keys array may be adapted to that of a telephone keypad layout by running a suitable user-executable program or driver which enables the layout to be changed accordingly, i.e. similar to the way the QWERTY layout of the keyboard may be changed to DVORAK layout by running the appropriate keyboard driver in a personal computer's operating system. Alternatively, the program may be embedded as read-only memory (ROM) in a calculator, personal computer or hand-held machine developed specially for the training and practice using the present invention.

The telephone's standard numeric keypad may be provided with a mode for entering alphanumeric characters according to the following Table III in addition to the numeric mode for generating dual tone multi-frequency (DTMF) signal.

TABLE III
Telephone keypad's alphanumeric input mode

| | | Numeric keys | | | | | | | | |
|---|---|---|---|---|---|---|---|---|---|---|
| | | 1 | 2 | 3 | 4 | 5 | 6 | 7 | 8 | 9 |
| No. of | 1 | | A | D | G | J | M | P | T | W |
| presses | 2 | | B | E | H | K | N | Q | U | X |
| | 3 | | C | F | I | L | O | R | V | Y |
| | 4 | | | | | | | S | | Z |

As described in the Background Art section, the telephone keypad's standard numeric keypad mode for entering alphanumeric characters may be modified to redistribute certain or all of the alphabets to be different from that shown in Table III, for example as proposed in the aforesaid US 2003/0048894-A1.

It will further be obvious to a skilled person that the methods of the present invention may be applied to a telephone's numeric keypad which is provided with a mode for entering radicals of a script which words comprises of such radicals so that a word in that script may be assembled. This includes East Asian languages' scripts, including Chinese, Japanese and Korean languages. Such mode may be enabled in the alternative in addition to the numeric mode for generating DTMF signal for telecommunications purposes.

The mnemonic device generator employed in the method of the present invention may be any suitable generator including a computer-implemented generator such as that of US 2003/0068604-A1 described above in the Background Art section. Typically, the mnemonic device is generated from a list of words or keywords to be memorised so that a representative letter or syllable of each keyword, such as the first letter of each keyword, is extracted to form an abbreviation or acronym, which is then inputted onto any one of the various layouts or variants of numeric keypads as discussed above. Essentially, the spatial arrangement of the inputting of the mnemonic device is recorded.

The generation of the mnemonic device generally involves the following steps, which we shall illustrate by showing the application of the method of the invention in respect of an example of keyword lists as follows.

Step (i)—The user or learner reads the material to be memorised and list down certain words or keywords that requires committing to memory.

### EXAMPLE I

### Leadership Styles

User has to remember a list of leadership styles, namely—User picks out a list of keywords e.g. different leadership styles, i.e.

“supportive, authoritarian, democratic, task-oriented and employee-focussed.”

Step (ii)—A representative letter or syllable of each of the words to be memorised are then extracted to a shortlist. Usually, the representative letter of syllable is the first letter or syllable of each of the keywords.

### EXAMPLE I(ii)

### Leadership Styles

The user lists out the keywords and picks the first alphabets of each keyword as follows:
supportive,
authoritarian,
democratic,
task-oriented, and
employee-focused.

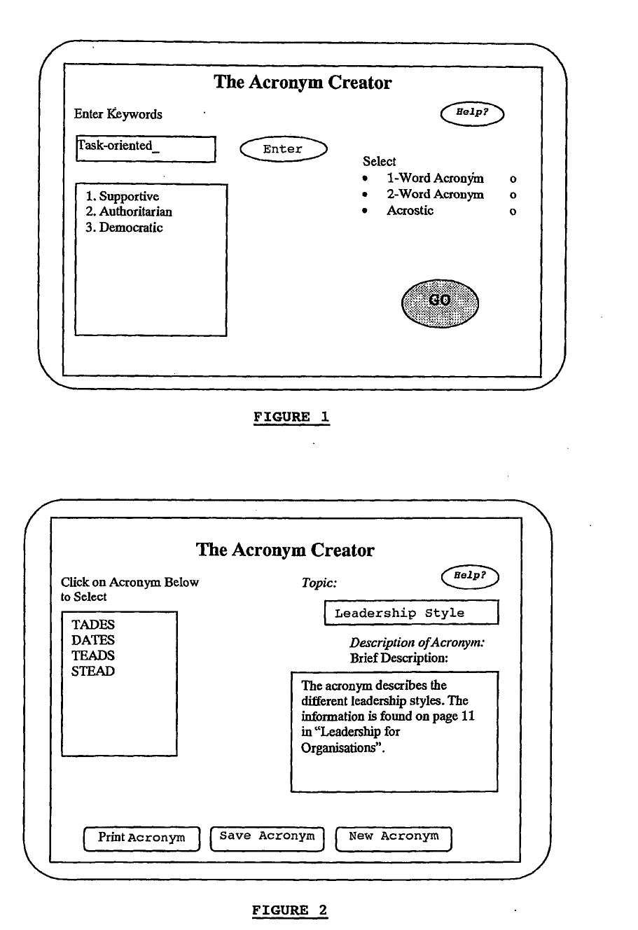

In a computer-implemented mnemonic device generator, a user interface display may be provided as shown in FIG. 1 wherein each of the keyword may be entered in an entry field and registered in a register field shown below the entry field. The program is captioned “The Acronym Creator” (TAC) to distinguish it from the generic mnemonic device generators such as that of US 2003/0068604-A1.

Step (iii)—The representative letters are arranged and rearranged to combine in different permutations so as to produce words as well as non-existent words (hereinafter to be referred to as “words” alike).

### EXAMPLE I(iii)

### Leadership Styles

S,A,D,T and E is summarised from the list of the keywords and are rearranged in different combinations and/or permutations:

| | | |
|---|---|---|
| SADTE | SDTEA | STEAD |
| SEADT | SEATD | SETAD |
| SEDAT | TESAD | TEADS |
| TEASD | TEDAS | TADES |
| DASTE | DESTA | DEAST |
| ESTAD | ESTDA | etc. |

Step (iv)—The program or user then chooses at least one combination of the alphabets that forms a word that has dictionary meaning or that is meaningful to himself/herself. If there is more than one meaningful word generated, the user will choose one that is most meaningful. In a computer-implemented method, the list of combinations and/or permutations is crosschecked with a database of words (dictionary or user's own vocabulary) and one with known or preferable meaning is picked. Preferably, the mnemonic device generated is a word formed of the representative alphabets as an acronym.

### EXAMPLE I(iv)

### Leadership Styles

STEAD which means “in the role of somebody or something else” is chosen as the acronym for the new order of keywords (i.e. leadership styles) list to be memorised:
supportive,
task-oriented,
employee-focused,
authoritarian,
democratic.

Another example may be shown:

### EXAMPLE II

### Characteristics of a Person

From the list of keywords of a person's characteristics:
aptitudes dominance, education, intelligence, interests, self-sufficiency, and spatial relations,

A,D,E,I,I,S and S is summarised from the list of the keywords and are rearranged in different combinations and/or permutations:
ADEIISS
AIDESIS
AISDEIS . . . , including DAISIES, is obtained.

Step (v)—The user will then input the generated word, i.e. the mnemonic device, onto a numeric keypad. The spatial arrangement or pattern in which the mnemonic device is inputted onto the numeric keypad is noted or recorded. On a computer-implemented method or mnemonic device generating program, the output of such an acronym or list of alternative acronyms generated may be shown in FIG. 2 wherein the user is provided with options to choose the most meaningful acronym, save the chosen acronym as the mnemonic device and print out the new order of the keywords list.

In another embodiment, particularly in a computer-implemented method, the list of words formed of the permutation of alphabets is crosschecked against a database of dictionary words whereby words having meaning are short-listed for the user to choose.

As shown in FIG. 1, apart from the option to generate a single-word acronym, the program may provide the user with the option where the list of words formed of the permutation of alphabets is grouped into two or more groups to correspondingly form two or more words. This alternative embodiment may be applied in respect of the following examples:

### EXAMPLES IIA

### Characteristics of a Person

From the list of keywords of a person's characteristics:
aptitude, dominance, education, intelligence, interests, self-sufficiency, and spatial relations
   Single word acronym: DAISIES
   Two-word acronym: ASS DIE

### EXAMPLE III

### Elements of Literature

The elements of a piece of literature:
protagonist, antagonist, setting, theme, conflict, action (or plot), and point of view
   single word acronym: PASTCAP
   Two-word acronym: PAT CAPS

### EXAMPLE IV

### Colours of Light Spectrum

The order of the light spectrum colours:
red, orange, yellow, green, blue indigo, violet.
   ROYGBIV which may be broken into 3 words or parts to resemble a person's name:
   Three-word device: Mr Roy G. Biv

A third option of generating mnemonic device that is acrostic may be provided in The Acronym Creator (TAC) program as illustrated in FIG. 1. Examples of such acrostics are provided in the following examples.

### EXAMPLE V

### Poetry's Figurative Forms

The figurative forms of poetry:
onomatopoeia, simile, metaphor, personification, oxymoron
   Acrostic: “Only some men play out”.

### EXAMPLE VI

### Aristotle's Ideal State

The six material conditions of the ideal state as proposed by Aristotle:
Population, limits, territory, access, egress and position.
   Acrostic: “Popovers, leftovers and turnovers are equally palatable”

Preferably still, the acrostic is formed from cross-checking words formed from the permutations of the alphabets' combination against a database of acrostic words, phrases, sentences and the like, including a database of dictionary words. As new mnemonic devices and acrostics are formed by the mnemonic generator, these new mnemonic or acrostic words may be added to the existing database so that it is constantly expanding for future cross-checks to provide faster search and more word-matching results. This is particularly advantageous when the method of the invention, such as the mnemonic device generator, database and cross-checking engine is implemented in a computer.

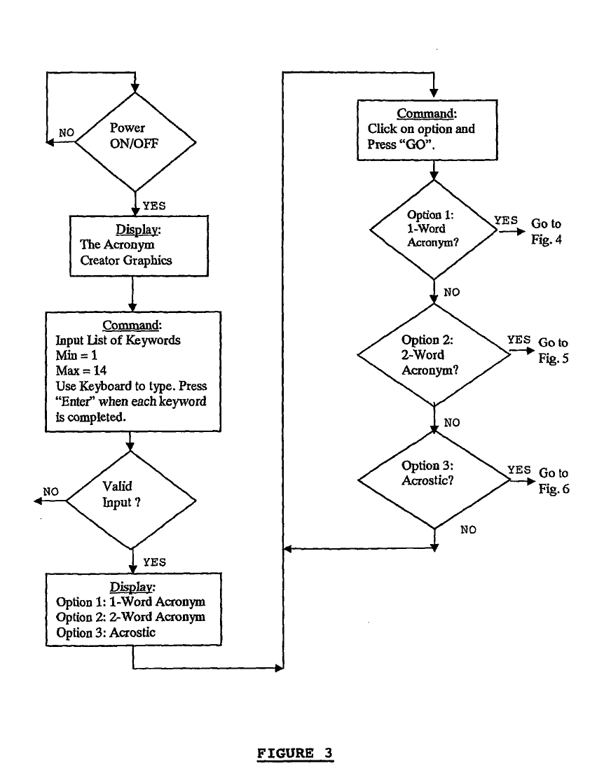

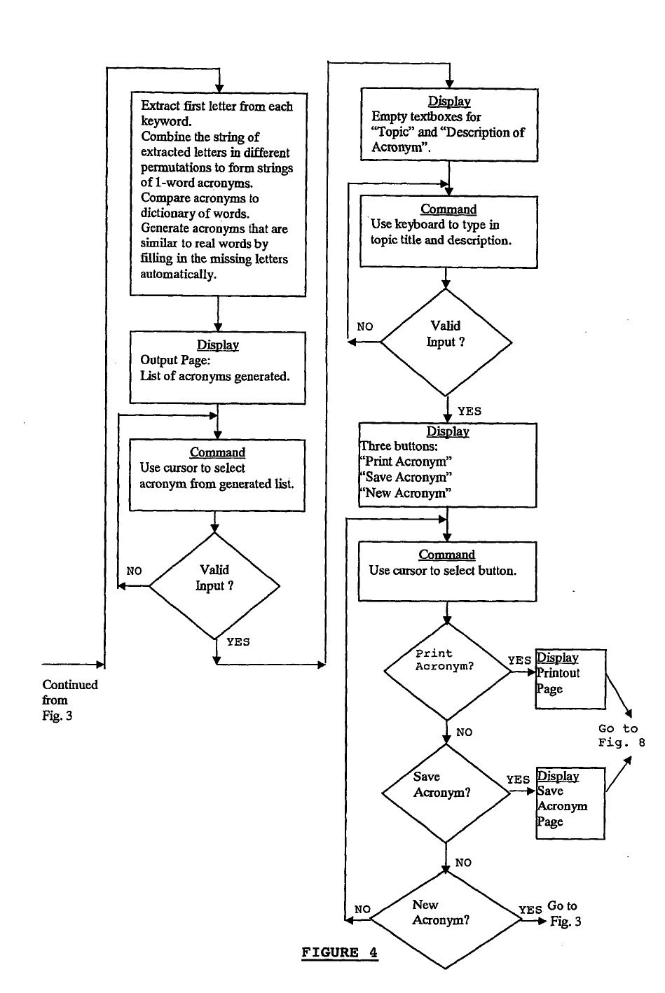

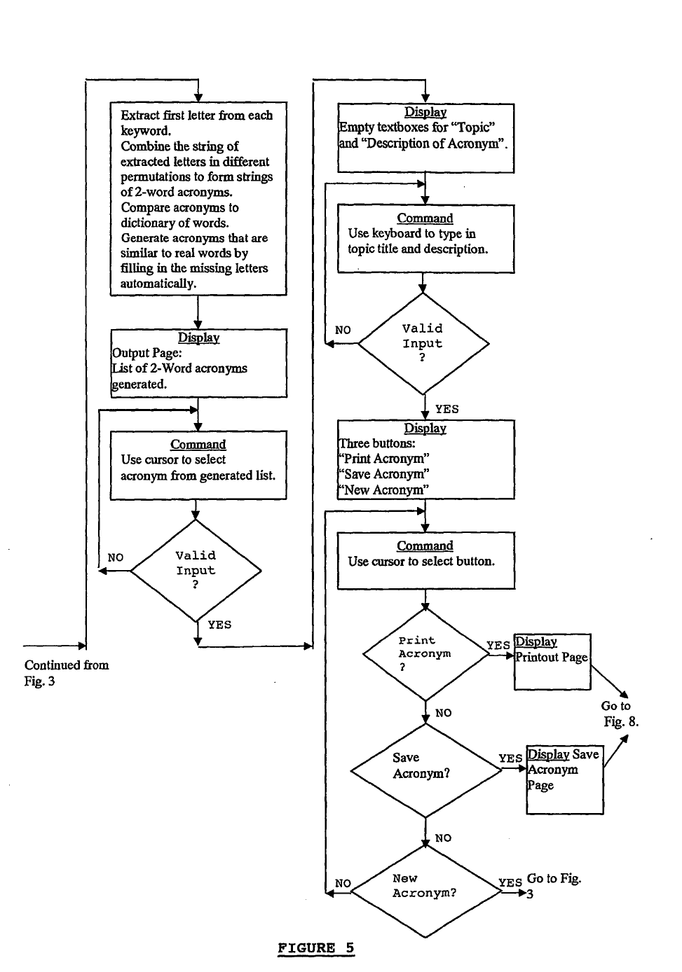

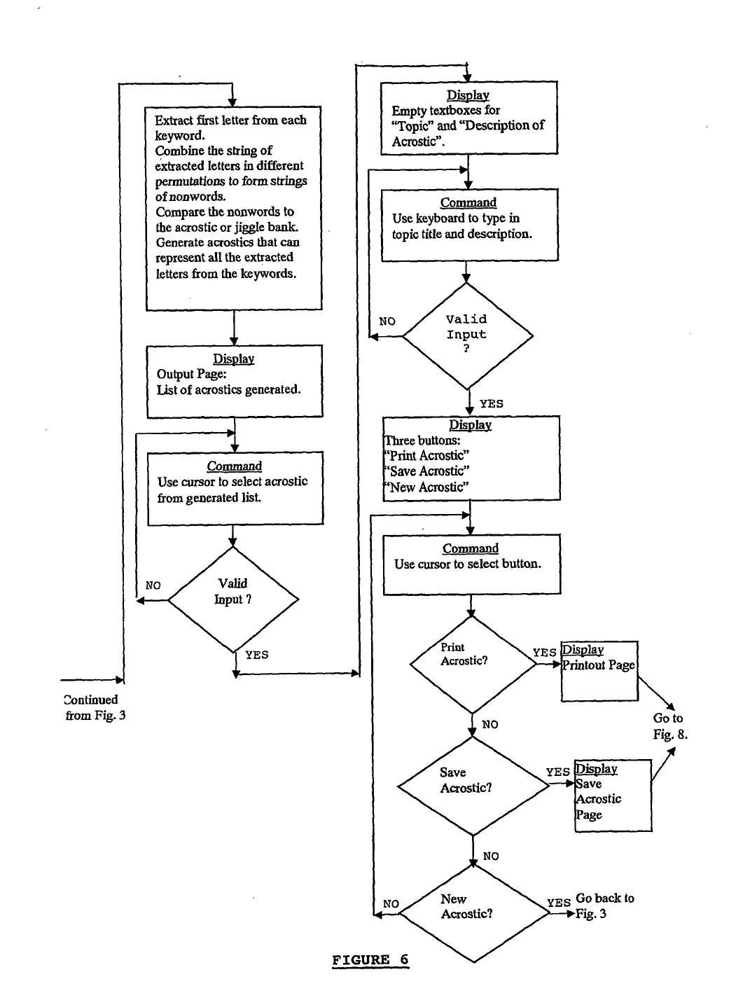

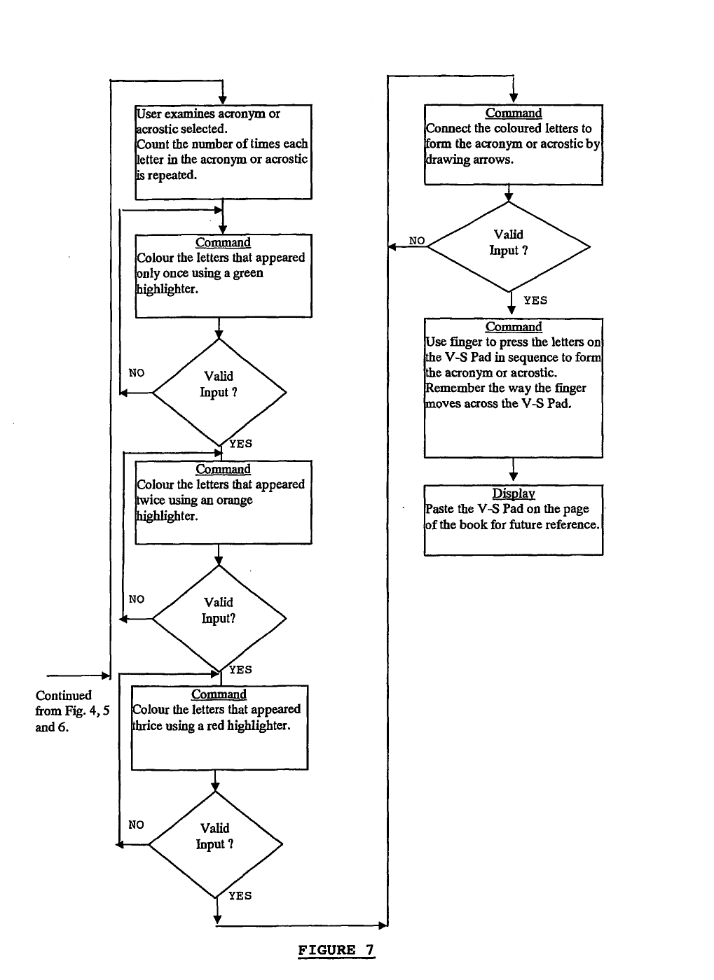

The logic flowchart of the acronym creator (TAC) is shown in FIGS. 3 to 7.

In an essential aspect of the invention, the method for inputting a mnemonic device on a numeric keypad comprises registering the spatial arrangement of the input on an input record means.

The term “input record means” is to be understood broadly to cover any form of record or register of any size, including electronically storable and retrievable means such as that implemented in a computer, and materials printed with the keypad layout so long as the input's visual-spatial arrangement may be marked or inputted thereunto by the user. Such printed materials include sheets, stickers, pads and even educational materials including margins of the relevant pages of a textbook which are pre-printed with such keyboard layouts for the user's recording or note-making upon successfully generating the mnemonic devices.

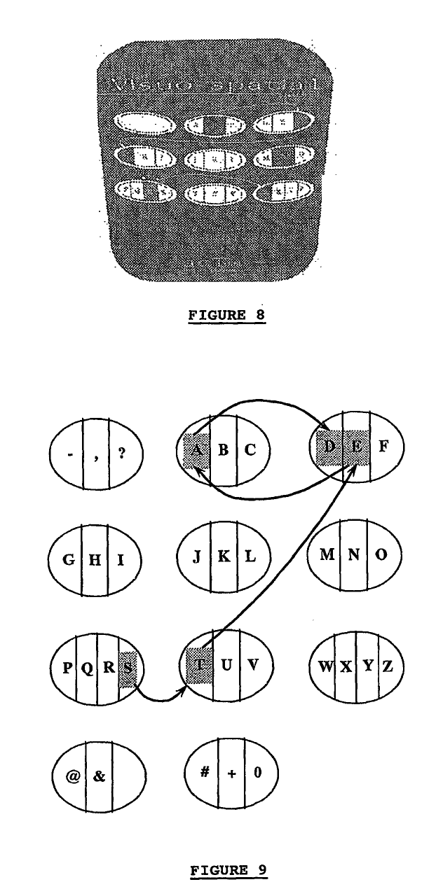

One specific embodiment of the input record means comprises a sheet provided with the keypad layout upon which the spatial arrangement in which the sequence of keys being pressed in respect of the mnemonic device being inputted may be practised and recorded. An example of such a sheet is shown in FIG. 8, which is trade-named Visuo-Spatial Pad™ or in short V-S Pad™.

FIG. 9 shows the spatial arrangement of the mnemonic device “STEAD” input on a worksheet of the V-S Pad™. Due to the natural proficiency of young learners to visual-spatial relationship, such recording of the spatial input of an acronym is likely to be better memorised and recalled by such learners.

To indicate the number of presses required to input a particular alphabet, a number of marking methods may be used. For example, as shown in FIG. 9, each of the numeric keys are divided into 3 or 4 portions depending on the number of alphabets represented thereon. The particular alphabet is then shaded or marked accordingly and arrows are drawn to link one alphabet to the next according to sequence of input.

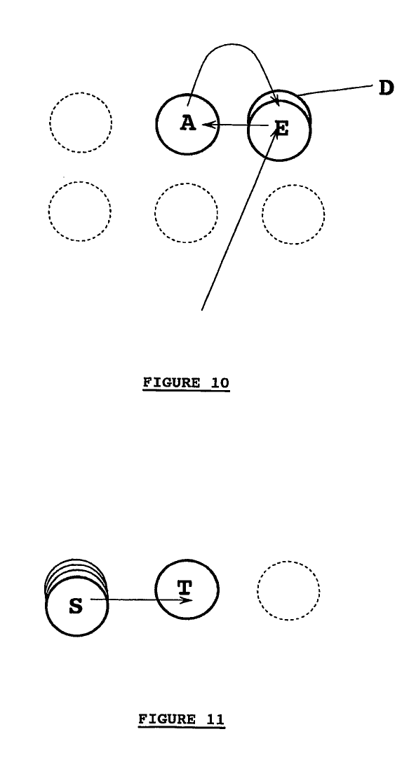

FIG. 10 shows another manner of indicating the number of presses, i.e. by drawing the corresponding number of circles over the particular numeric key to input the particular alphabet. Other methods for indicating the number of presses not shown herein include marking with colour codes or varying greyscales, sticking colour-coded dots, etc.

Other embodiments of the input record means may be provided apart from the V-S Pad™. This include V-S Mat™ which is a mat version enabling footsteps as input onto the larger version of the keypad, equivalent to the step-on mat for cursor control of computer games for personal computer and game console sets. Such large versions of the visual-spatial pads may also be hung on the wall for ease of reference and display.

Another variation of the V-S Pac™ embodiment is the V-S Card™ which is a card version for users to collect, assemble and organise with ease as in the case of flash cards. An improved version of such cards may include tactile buttons in place of the numeric keys so that multiple times pressed to input the requisite alphabet may be practised by the user.

A particularly preferred embodiment of the input record means is V-S Stick-I™ in the form of a sticker, which is printed with the keypad's layout thereon. The sticker may be dispensable from a stack in convenient size like the 3M's Post-It™ yellow stickers so that a user may manually register the input's spatial arrangement thereon and paste the recorded sticker onto a page containing the relevant educational or instructional materials to be memorised. In this manner, the stickers may be conveniently used on textbooks, workbooks and students' own notes where there is a list of keywords to be memorised.

In another preferred embodiment, the record may be provided in the form of a computer-implemented entry and storage for retrieval to be output to a visual display. It may also be retrieved to replay in animation form the input's spatial arrangement, i.e. animating the sequence of keys being pressed to input the mnemonic device such as a short movie (MPEG, AVI, etc.) or PowerPoint presentation so that the visual-spatial aspect of the record's entry may be shown to the learner.

The record retrieval may also be used to test a user for correct input of the mnemonic device to reinforce his memory during practise session or even used as an actual test. The record may also preferably be incorporated into a database, hence expanding said database for enhancing future use and implementation.

In yet another preferred embodiment, the virtual replay of the input's spatial arrangement is provided as a routine or subroutine in the mnemonic device generator program whereby the replay of the mnemonic device's input on the keypad is weighted preferentially according to pre-selected patterns according to how the input can be best identified and remembered. In this embodiment, when the mnemonic device generator produces more than one word or acronym, the words will be arranged according to pre-selected preferential spatial patterns such as squares, triangles, straight lines, diagonally across, etc.

The acronym generator may be configured to generate the input spatial patterns of all the formed acronyms and make a recommendation, based on the aforesaid preferential basis, a short-listed number of acronyms according to their adherence to the weighting basis provided by the user or the stated specific spatial patterns. As an example, if the acronym recorder is to be inputted on the keypad of a mobile phone, the mnemonic device generator produces a choice of either “DOW” or “DOT” as acronyms, the routine or subroutine will prefer and recommend “DOW” as it forms an easy way to remember the specific spatial pathway i.e. a straight line down in three steps.

It will also be obvious that the method of inputting a mnemonic device on a numeric keypad wherein the spatial arrangement of the input may be recorded is independent of the mnemonic generation step, i.e. the method of the basic embodiment of the invention may be practised without having to generate a mnemonic device in respect of the material to be memorised. This is particularly the case for non-textual information such as mathematical formulas. For example, the Pythagoras theorem, A²+B²=C² may be simplified for spatial input purposes by designating the square to “2” so that the equation may be inputted as A2+B2=C2. Similarly, other equations such as Newton's second law may be entered as F=MA and relationship of electrical power may be entered as P=IV.

It will be appreciated by a person skilled in the art that there may be other variations or embodiments for provided means to record the input of the mnemonic device for practice or for record and storage for future reference. Colour coded dots stickers may be pasted onto the representative keypad layout (in the form of V-S Pad™, V-S Card™, V-S Stick-It™, etc.) instead of colouring, shading or marking manually. Instead of printed materials, rubber stamps bearing the imprint of the keypad layout may be used to stamp at the appropriate margins of a textbook or space of a workbook to implement the method of this invention.

It will also be apparent to a skilled person that there are many other variations of mnemonic devices generating methods not specifically described herein. This includes the insertion of secondary letters into the acronyms to form a meaningful word such as in the STEAD example above, the non-words TEASD and SEDAT may have a secondary “e” inserted to make the word TEASeD and SEDATe respectively. These generating methods may be implemented with the method of the invention without much adaptation or modification.

These and other possible modifications and variations of the general inventive concept of transferring the generated mnemonic device to be entered in a visual-spatial input means which are not specifically described herein are not to be considered as departures from the present invention and shall be considered as falling within the letter and scope of the following claims.

1. A method for inputting a piece of information, including a mnemonic device, on a numeric keypad wherein the spatial arrangement of the input is recorded.

2. A method according to claim 1 wherein the numeric keypad includes any one of a telephone keypad layout, a calculator keypad layout and a computer keyboard's numeric keys array.

3. A method according to claim 2 wherein the numeric keypad is provided with a mode for entering alphanumeric characters according to the following table in addition to the numeric mode for generating dual tone multi-frequency (DTMF) signal.

| | | Numeric keys | | | | | | | | |
|---|---|---|---|---|---|---|---|---|---|---|
| | | 1 | 2 | 3 | 4 | 5 | 6 | 7 | 8 | 9 |
| No. of | 1 | | A | D | G | J | M | P | T | W |
| presses | 2 | | B | E | H | K | N | Q | U | X |
| | 3 | | C | F | I | L | O | R | V | Y |
| | 4 | | | | | | | S | | Z |

4. A method according to claim 2 wherein any one of the numeric keypad of the calculator and computer keyboard's numeric keys array includes a user-executable program enabling the layout to be changed to that of a telephone keypad layout.

5. A method according to claim 2 wherein the numeric keypad is provided with a mode for entering radicals of an East Asian language script, including any one of Chinese, Japanese and Korean, in addition to the numeric mode for generating DTMF signal.

6. A method for generating a mnemonic device from a list of keywords to be memorized and inputting said generated mnemonic device on a numeric keypad wherein the spatial arrangement of the input is recorded.

7. A method according to claim 1 wherein the mnemonic device is generated by the steps of:
(i) arranging the keywords to be memorized in a list;
(ii) short-listing said keyword list by the first alphabet of each keyword;
(iii) rearranging said first alphabets to combine in different permutations;
(iv) choosing at least one combination of the alphabets that forms a word meaningful to a user;
(v) said user inputs said word onto a numeric keypad and record the spatial arrangement of the input.

8. A method according to claim 7 wherein the word formed of the alphabets' combination includes an acronym.

9. A method according to claim 7 wherein a plurality of the alphabets' combination comprises words and a word most meaningful to the user is chosen.

10. A method according to claim 7 wherein the list of words formed of the permutation of alphabets is crosschecked against a database of dictionary words whereby words having meaning are short-listed for the user to choose.

11. A method according to claim 7 wherein the list of words formed of the permutation of alphabets is grouped into at least two groups to form at least two words.

12. A method according to claim 7 wherein the mnemonic device generated in the form an acrostic.

13. A method according to claim 12 wherein the acrostic is formed from cross-checking words formed from the permutations of the alphabets' combination against a database of acrostic words, phrases, sentences and the like.

14. A method according to claim 6 wherein the generated acrostics, including words, which are new to the database, are incorporated thereinto, hence expanding said database for future crosschecking.

15. A method according to claim 6, wherein the database and the crosschecking engine is implemented in a computer.

16. A method for inputting a mnemonic device on a numeric keypad wherein the spatial arrangement of the input is registered on an input record means.

17. A method according to claim 16 wherein the input record means is embodied as a sheet provided with the keypad layout upon which the spatial arrangement in which the sequence of keys being pressed in respect of the mnemonic device being inputted may be practiced and recorded.

18. A method according to claim 16 wherein the input record means is a mat provided with the keypad layout upon which the spatial arrangement comprising the sequence of keys being pressed in respect of the mnemonic device being inputted may be performed with footsteps of the user.

19. A method according to claim 17 wherein the sheet is comprised of a sticker dispensable from a stack in convenient size for manually registering the input's spatial arrangement and for sticking onto a page containing educational or instructional materials.

20. A method according to claim 16 wherein the record is in the form of a computer-implemented storage which is retrievable for any one or combination of the functions of
output to a visual display;
animation replay of the input's spatial arrangement;
test a user for the correct input; and
incorporate said record into a database, hence expanding said database for enhanced future implementation.

21. A method according to claim 16 wherein more than one mnemonic device is generated and the spatial arrangement of inputting each of said mnemonic devices is weighted according to pre-selected input pattern preference, and wherein said mnemonic devices are then arranged according to said weighted preference for a user's selection.

22. An apparatus for implementing a method for inputting a piece of information, including a mnemonic device on a numeric keypad wherein the spatial arrangement of the input is recorded.

23. An apparatus according to claim 22 wherein the keypad includes any one of a telephone keypad layout, a calculator keypad layout and a computer keyboard's numeric keys array.

24. An apparatus according to claim 22 including means for implementing a virtual keyboard.

25. An apparatus for implementing a method according to claim 6.

26. An article for implementing a method according to claim 16.
